(19) United States
(12) Patent Application Publication
(10) Pub. No.: US 2026/0066519 A1
(43) Pub. Date: Mar. 5, 2026

(54) MULTI-USE RADIO ANTENNA MOUNT

(71) Applicant: Michael Giannaccio, Pearland, TX (US)

(72) Inventor: Michael Giannaccio, Pearland, TX (US)

(21) Appl. No.: 19/286,938

(22) Filed: Jul. 31, 2025

Related U.S. Application Data
(60) Provisional application No. 63/688,958, filed on Aug. 30, 2024.

(51) Int. Cl. H01Q 1/12

(52) U.S. Cl. CPC H01Q 1/1235; H01Q 1/1228

(57) ABSTRACT

A multi-use antenna mount that can be used in a variety of different configurations for holding and mounting one or more antennas in different orientations may include a cylindrically (or prismatic) shaped, hollow main body and four different attachment points on multiple surfaces of the main body. In some embodiments, a first attachment point is a coaxial antenna cable connector. A second attachment point is a top, internally-threaded, coupler nut that can accept externally-threaded antenna elements. A third attachment point is a bottom, externally-threaded stud. A fourth attachment point is a recessed, internally-threaded hole disposed through a recessed flat surface on a side wall of the antenna mount's main body. All electrical connections are made inside of the hollow body of the antenna mount. A plurality of small radial holes may be used to mechanically attach and electrically connect a plurality of radial ground wires.

### REFERENCE TO RELATED APPLICATIONS

This application claims the benefit of U.S. Provisional Patent Application Ser. No. 63/688,958 filed Aug. 30, 2024, which is incorporated herein by reference in its entirety.

### INTRODUCTION

This disclosure relates to a multi-use radio antenna mount that can be used in a variety of different configurations for holding and mounting one or more antennas at different orientations.

Antennas are used for radio frequency (RF) communications by amateur radio enthusiasts (HAM radio operators, worldwide), commercial, scientific, aircraft, motor vehicle, spacecraft, and military applications.

Examples of popular radio antennas include: (1) dipole antennas comprising a pair of horizontally-oriented antenna sticks or wires that point in opposite directions from a central location, (2) horizontal or vertical full-wave loop antennas (e.g., quad-loops or delta-loops), (3) vertical monopole antennas with a plurality of ground radials, (4) Yagi and Logarithmic directional antennas, (5) end-fed, half-wave long wire antennas, (6) off-center fed long wire antennas, (7) phased antenna arrays, (8) helical antennas, and many more. Such monopole antennas may be semi-rigid, telescoping antennas that can reach as high as 17 feet vertically (or more). These different antenna systems may be mounted at various heights above the ground on vertical poles, fixed towers, hung from free-standing guyed poles, or hung from tree branches. Antennas may be designed to be resonant on a single radio frequency, or they may be multi-band antennas that resonant at different harmonic frequencies, or they may be broadband antennas that use antenna tuners to minimize standing wave ratios.

### SUMMARY

The present disclosure relates to multi-use antenna mounts that may be used in a variety of different configurations for holding and mounting one or more antennas at different orientations. The various embodiments disclosed herein provide simple, compact, strong, lightweight, inexpensive, and easily modified antenna mounts for attaching and holding multiple different configurations of radio antenna(s) in many different orientation(s).

The antenna mount may have a cylindrically shaped (or prismatic or cubically shaped) hollow main body, and may have as many as four different attachment points on multiple surfaces of the main body. In some embodiments, a first attachment point may be a coaxial antenna cable connector. A second attachment point may be a top internally-threaded coupler nut that can accept, for example, externally-threaded antenna elements. A third attachment point may be a bottom, externally-threaded stud that can accept an internally-threaded coupler or be used to attach the mount to a tripod base or a ground spike. A fourth attachment point may be an internally-threaded hole disposed through a recessed flat surface on a side wall of the antenna mount's main body that can hold an L-bracket for mounting to a pole. All electrical connections are made inside of the hollow body of the antenna mount. A plurality of small radial (or orthogonal) holes may be evenly spaced around the circumference of a cylindrical (or around the four sides of a cubical) antenna mount and may be used to mechanically attach and electrically connect a plurality of radial ground wires to the antenna mount.

In one embodiment, an antenna mount includes a cylindrical main body having a vertical partially-threaded first central hole, a radial side thru-hole, a vertical threaded bottom hole, and a recessed threaded side radial hole. The main body also has a first recessed flat side surface, a second recessed flat side surface, and a hollow interior volume defined by the partially-threaded first central hole. A centerline of the vertical partially-threaded first central hole is coincident with a centerline of the cylindrical main body.

The antenna mount may further include a cylindrical top cap screwed into the vertical partially-threaded first central hole in the cylindrical main body. The cylindrical top cap includes an upper cylindrical portion, an integral externally-threaded lower cylindrical portion, and a second central hole. The antenna mount may further include an inverted central bolt extending upwards through the second central hole of the cylindrical top cap.

In another embodiment, the antenna mount further includes a central threaded stud that is screwed into the vertical threaded bottom hole.

In another embodiment, the cylindrical main body further includes a plurality of radially-oriented, uniformly spaced radial holes configured for holding and electrically connecting a plurality of radial ground wire connectors to the cylindrical main body. The recessed threaded radial side hole may be positioned on an opposite side of the cylindrical main body from the radial side thru-hole. The cylindrical main body and the cylindrical top cap may be made of aluminum or an aluminum alloy.

In another embodiment, the antenna mount may include an L-shaped bracket with two mounting holes and a 90-degree bent tab attached with a nut to a threaded stud that is screwed into the recessed threaded radial side hole in the second recessed flat side surface of the cylindrical main body. The antenna mount may have a central threaded stud that is screwed into the vertical threaded bottom hole. In some embodiments the central threaded stud is screwed into a tripod disc of a tripod having three legs.

In other embodiments the second recessed flat side surface is vertically aligned at a mid-point of the cylindrical main body. The antenna mount may be attached to a vertical pole with a U-shaped bolt. A horizontal, opposing pair of telescoping dipole antennas are attached to the antenna mount attached to the vertical pole.

In other embodiments, the second recessed flat side surface is vertically aligned at a mid-point of the cylindrical main body. The antenna mount may be attached to a vertical pole with a U-shaped bolt. A horizontal, opposing pair of telescoping dipole antennas are attached to the antenna mount attached to the vertical pole.

In other embodiments, the cylindrical top cap has a same outer diameter as the cylindrical main body. Additionally, the integral, externally-threaded, lower cylindrical portion of the cylindrical top cap may have a smaller outer diameter than an outer diameter of the cylindrical top cap.

In other embodiments, the antenna mount may further include an insulating sleeve washer disposed in-between the inverted central bolt and the second central hole of the cylindrical top cap. A coaxial connector may be secured in the radial side thru-hole with an integral flange that is screwed to the cylindrical main body at four places. An insulating sealing washer may be placed in-between a head of the inverted central bolt and a bottom surface of the integral, externally-threaded, lower cylindrical portion of the cylindrical top cap.

In other embodiments, the inverted central bolt is electrically insulated from the cylindrical main body and the cylindrical top cap. The first recessed side flat surface has a first vertical height, A, and the second recessed side flat surface has a second vertical height, B, where A>B. Each radial ground wire may have an electrical connection to the plurality of radially-oriented, uniformly spaced radial holes in the cylindrical main body comprising a banana plug, a magnetic sleeve, or a threaded metallic sleeve.

In other embodiments, the radial side thru-hole is centered on, and passes through, the first recessed side flat surface, and the recessed threaded radial side hole passes through the second recessed side flat surface.

In other embodiments, a first hex nut is threaded onto the inverted central bolt and disposed above the insulating sleeve washer. The antenna mount may include a bent insulated wire placed inside of the hollow interior volume, and where the coaxial connector has a center conductor that is electrically connected to the inverted central bolt via the bent insulated wire. A shield of the coaxial connector may be electrically connected to the cylindrical main body and the cylindrical top cap. Additionally, the second recessed flat side surface and the coaxial connector are aligned on a same centerline.

In other embodiments, the antenna mount may include a first hex coupling nut partially-threaded onto the inverted central bolt and disposed above the first hex nut, a second hex coupling nut screwed onto a central threaded stud screwed into the vertical threaded bottom hole in the cylindrical main body, and a split ring attached with a cylindrical nut and a jam nut to a threaded stud screwed into the recessed threaded radial side hole. A first hex coupling nut may be partially-threaded onto the inverted central bolt and disposed above the first hex nut.

In other embodiments, the antenna mount may include a modified ring terminal that has a 90-degree bent-over circular ring, where the bent insulated wire is attached to the modified ring terminal and where the 90-degree bent-over circular ring is placed over the inverted central bolt and makes electrical contact with a head of the inverted central bolt.

### BRIEF DESCRIPTION OF THE DRAWINGS

FIG. 1 shows an exploded elevation view of an example of a cylindrical, hollow antenna mount.

FIG. 2 shows a side elevation view of an example of a cylindrical, hollow antenna mount.

FIG. 3 shows a front elevation view of an example of an antenna assembly with a split ring for holding the antenna mount above the ground.

FIG. 4 shows a front elevation view of an example of an antenna assembly for use with an antenna mount for a dipole wire antenna configuration.

FIG. 5 shows a front elevation view of an example of an antenna mounting assembly with an attached bracket for attaching an antenna mount to a pole or other mounting surface.

FIG. 6 shows a front elevation view of an example of an antenna mounting assembly with an antenna mount for use with a pair of telescoping dipole antennas mounted to a vertical pole.

FIG. 7 shows a side elevation view of the antenna mounting assembly shown in FIG. 6 for mounting a pair of telescoping dipole antennas to a vertical pole.

FIG. 8 shows a top (plan) view of the antenna mounting assembly shown in FIG. 6 for mounting a pair of telescoping dipole antennas to a vertical pole.

FIG. 9 shows a perspective view of an example of an L-shaped mounting bracket.

FIG. 10 shows a perspective view of an example of an L-shaped mounting bracket.

FIG. 11 shows a top (plan) view of an example of an L-shaped mounting bracket.

FIG. 12 shows a front elevation view of an example of an L-shaped mounting bracket.

FIG. 13 shows a bottom (plan) view of an example of an L-shaped mounting bracket.

FIG. 14 shows a front elevation view of an example of an antenna assembly for use with a telescoping vertical monopole antenna system mounted to an antenna mount mounted to a tripod with three legs and with a plurality of radial ground wires.

FIG. 15 shows a side elevation view of an example of a cylindrical, hollow antenna mount with a coaxial socket and three different attachment features.

FIG. 16 shows a front elevation view of an example of a cylindrical, hollow antenna mount with a coaxial socket and two different attachment features.

FIG. 17 shows a rear elevation view of an example of a cylindrical, hollow antenna mount with three different attachment features.

FIG. 18 shows a cross-section side elevation view of an example of a cylindrical, hollow antenna mount with three different attachment features.

FIG. 19 shows a cross-section (Sec A-A) side elevation view of an upper section of an example of a cylindrical, hollow antenna mount.

FIG. 20 shows a perspective view of an example of a cylindrical, hollow antenna mount.

FIG. 21 shows a perspective view of an example of a cylindrical, hollow antenna mount.

FIG. 22 shows a perspective view of an example of a cylindrical, hollow antenna mount.

FIG. 23 shows a perspective view of an example of a cylindrical, hollow antenna mount.

FIG. 24 shows a top view of an example of a cylindrical, hollow antenna mount.

FIG. 25 shows a bottom view of an example of a cylindrical, hollow antenna mount.

FIG. 26 shows a side elevation view of an example of a modified ring terminal.

FIG. 27 shows a top view of an example of a modified ring terminal.

FIG. 28 shows a perspective view of an example of a modified ring terminal.

FIG. 29A shows a side elevation view of an example of a cylindrical top cap.

FIG. 29B shows a side elevation cross-section view (section B-B) of an example of a cylindrical top cap.

FIG. 30 shows a side elevation cross-section view (section C-C) view of an example of a main body of a cylindrical, hollow antenna mount.

FIG. 31 shows a side elevation cross-section view (section D-D) view of an example of a main body of a cylindrical, hollow antenna mount.

FIG. 32 shows a perspective view of an example of a Z-Pod™ tripod base.

FIG. 33 shows a perspective view of an example of a cubic, hollow antenna mount.

FIG. 34 shows a side elevation view of an example of a cubic, hollow antenna mount.

FIG. 35 shows a perspective view of an example of a cylindrical main body.

FIG. 36 shows a perspective view of an example of a cylindrical main body.

FIG. 37 shows a perspective view of an example of a cylindrical main body.

FIG. 38 shows a perspective exploded view of an example of a cylindrical main body and a cylindrical top cap.

FIG. 39 shows a perspective exploded view of an example of a cylindrical main body and a cylindrical top cap.

### DETAILED DESCRIPTION OF THE DISCLOSURE

The antenna mounts and antenna mount systems described in this disclosure may be used for a variety of antenna systems, including, but not limited to: (1) dipole antennas comprising a pair of horizontally-oriented antenna sticks or wires that point in opposite directions from a central location, (2) horizontal or vertical full-wave loop antennas (e.g., quad-loops or delta-loops), (3) vertical monopole antennas with a plurality of ground radials, (4) Yagi and Logarithmic directional antennas, (5) end-fed, half-wave long wire antennas, (6) off-center fed long wire antennas, (7) phased antenna arrays, (8) helical antennas, and many more.

The phrase “Multi-Use” as it applies to radio antenna mounts of the present disclosure means that multiple, different components may be attached (e.g., screwed) to the main body of the antenna mount, in different orientations (including vertical and horizontal orientations with respect to the ground). The word “antenna” means any electrically conductive object, which includes, for example, wires, rods, and tubes made of copper or aluminum or composites with conductive graphite fibers, which have a length that is much greater than their diameter. An “antenna” can also comprise a flat or curved sheet or stripe of electrically conductive material. The term “radio frequency” generally refers to sinusoidal electromagnetic radiation. HAM radio frequencies generally range from 1 MHz to 5 GHz. The words “cubic” and “cubical” and “prismatic” are broadly defined as including both perfect cubes and elongated (i.e. trapezoidal or prismatic) shapes that are longer in at least one direction (e.g., the Z-direction) than the other two orthogonal dimensions. All three external dimensions of a prismatic antenna mount may be different from each other.

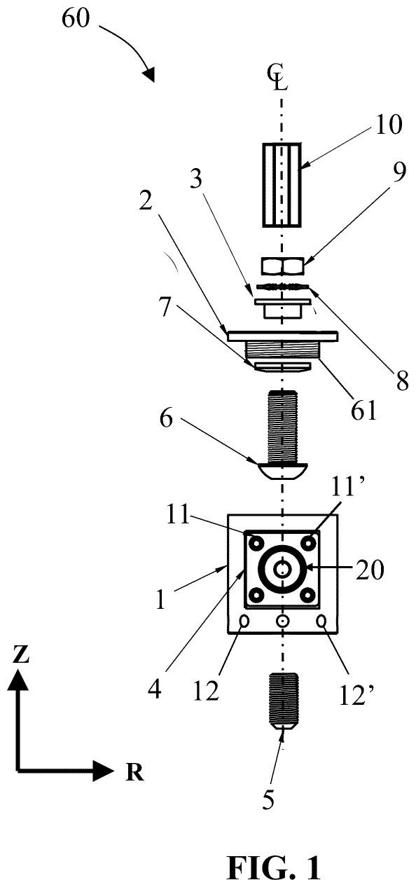

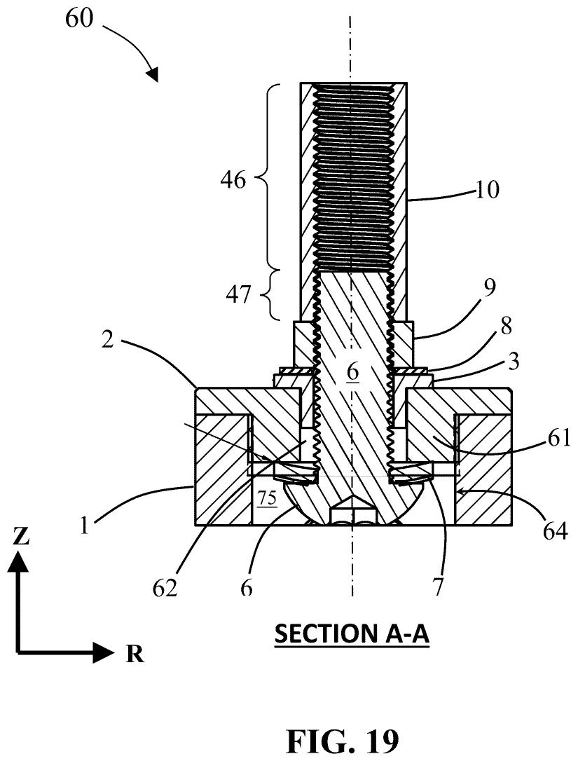

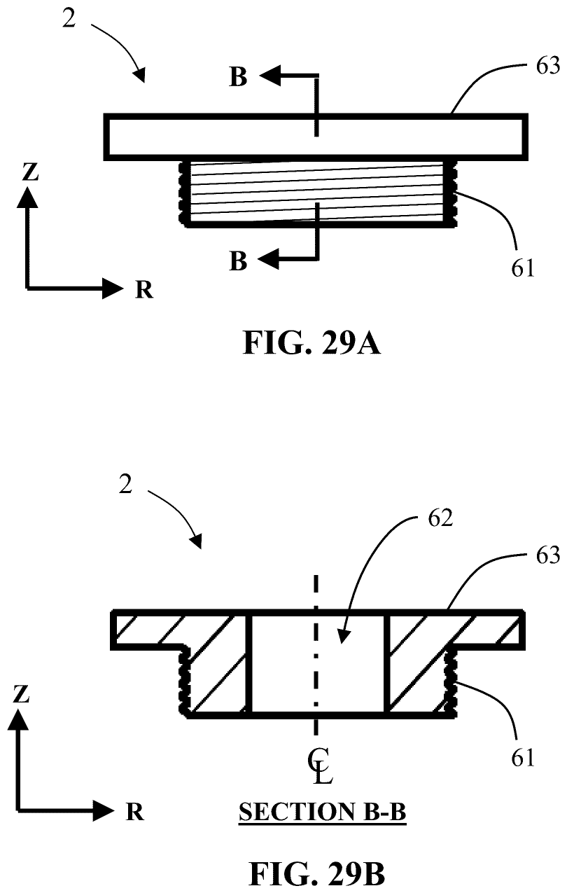

FIG. 1 shows an exploded elevation view of an example of a cylindrical, hollow antenna mount 60. Mount 60 has a central axis (Z-axis) and a radial axis (R-axis) in cylindrical coordinates. Antenna mount 60 can comprise at least twelve different components that are mostly attached by screwing them together along the central Z-axis (but, sometimes in other directions). Cylindrical main body 1 of mount 60 is a hollow, right cylinder with a length-to-diameter aspect ratio of about 1.1 (which can range from about 1.0 to 1.5). Cylindrical top cap 2 is a cylindrical component that has an externally-threaded lower cylindrical portion 61 which screws into the top of main body 1 (which is internally threaded to receive top cap 2). Inverted, button-head hex-drive central bolt 6 is oriented along the Z-axis and inserts from underneath of top cap 2 into a thru hole 62 in top cap 2 (see FIGS. 19, 29A, and 29 B). Insulating seal washer 7 has an attached rubber (which can be neoprene rubber or other elastomeric resilient material) seal ring and is disposed in-between the head of bolt 6 and the lower cylindrical portion 61 of top cap 2.

Electrically insulating sleeve washer 3 (which can be made of Nylon 6-6), inserts into thru-hole 62 in top cap 2 (see FIGS. 19, 29A and 29 B). Thin hex nut 9 screws onto inverted central bolt 6, with an internal-tooth lock washer 8 disposed in-between insulating sleeve washer 3 and thin nut 9. Above thin nut 9 is a first coupling hex nut 10 that screws onto inverted central bolt 6. All of the following parts: 6, 7, 8, 9, and 10 are co-axially aligned and stacked above one another, as shown in FIG. 1. Inverted central bolt may be a button-head hex-drive type of bolt.

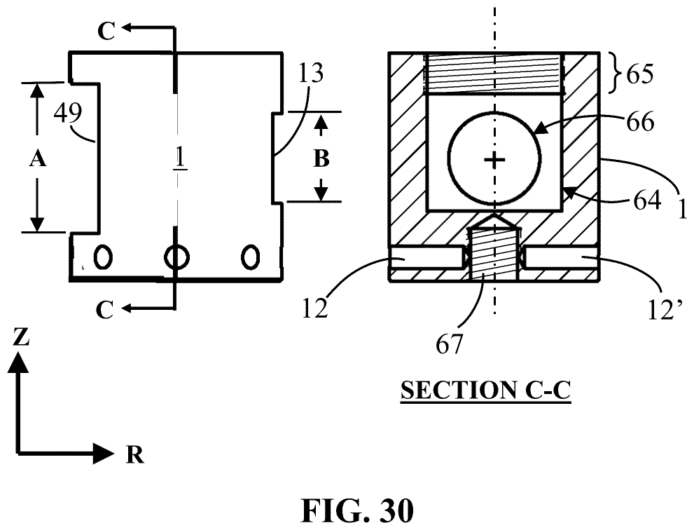

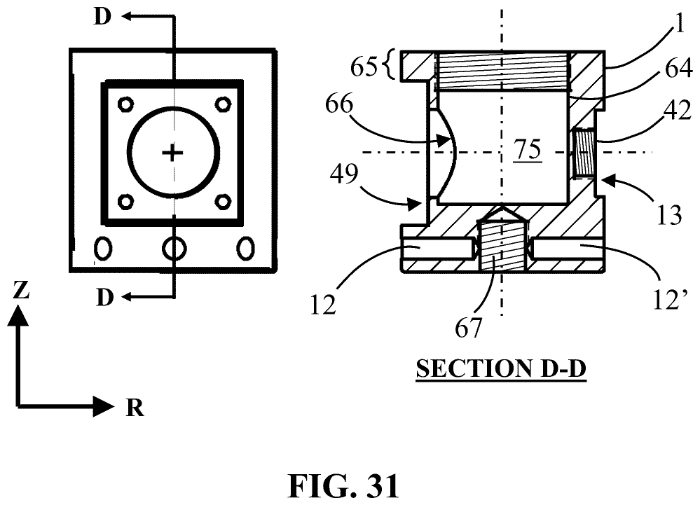

Referring still to FIG. 1, coaxial connector mounting flange 4 with an integral threaded female or male (preferably female) coaxial connector 20 is attached to main body 1 with four threaded socket head screws 11, 11′, etc. Near the bottom of main body 1 are a plurality of small radial holes (mounting ports) 12, 12′ etc. that are spaced evenly around the circumference of main cylindrical body 1. The number of radial holes can range from 2, 3, 4, 5, 6, 7, 8, 9, 10, or more radial holes. Attached to the bottom of body 1 is a cup-point set screw 5, which partially screws into a bottom threaded hole (67) in body 1 (see item 67 in FIGS. 30 and 31). The following metallic parts: 5, 6, 7, 8, 9, 10, and 11 may be made of stainless steel, in some embodiments. Main body 1 and top cap 2 may be made of aluminum or an aluminum alloy (e.g., 6061 aluminum alloy). Aluminum parts may be anodized to provide a hard, colored surface (e.g., black).

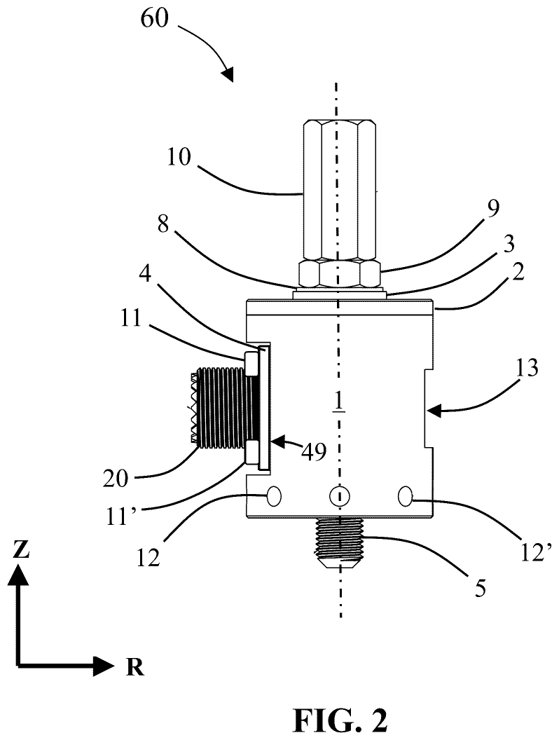

FIG. 2 shows a side elevation view of an example of a cylindrical, hollow antenna mount 60. Main body 1 comprises a first recessed flat side surface 13 and a second recessed flat side surface 49, which are aligned horizontally and are disposed on opposite sides of main body 1. The planes of flats 13 and 49 have a normal direction that is perpendicular to the centerline of mount 60 (i.e., the normal directions of recessed flats 13 and 49 are perpendicular to the Z-axis and are co-incident with the radial R-axis). Mount 60 further comprises a coaxial connector 20, which is illustrated as a SO-239 UHF female-type coaxial connection with external threads. Integral coax flange 4 is integrally attached to coaxial connector 20, and flange 4 is attached to recessed flat surface 49 of body 1 with four screws 11, 11′, etc. In some embodiments, coaxial connector 20 may be a male PL-259 type of coaxial connection.

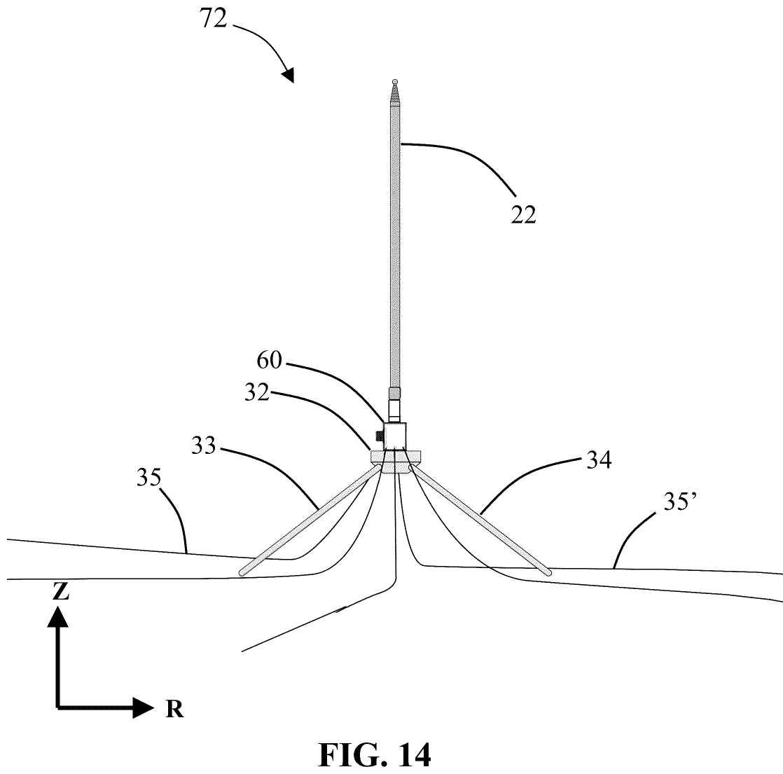

The main body 1 has a plurality of radial holes 12, 12′, etc. near the bottom of body 1 that are evenly spaced apart circumferentially around the cylindrical body 1. Externally threaded stud 5 is attached (e.g., screwed) to the bottom of body 1, and may be attached to a tripod (see, e.g., FIG. 14), a ground spike, or any other mating attachments, as needed. As previously described in reference to FIG. 1, main body 1 comprises a cylindrical top cap 2, which is attached to main body 1. Next, electrically insulating sleeve washer 3 is disposed above top cap 2. Next, internal-tooth lock washer 8 is disposed above sleeve washer 3. Next, thin hex nut 9 is attached above lock washer 8. Finally, first coupling hex nut 10 is attached above thin hex nut 9.

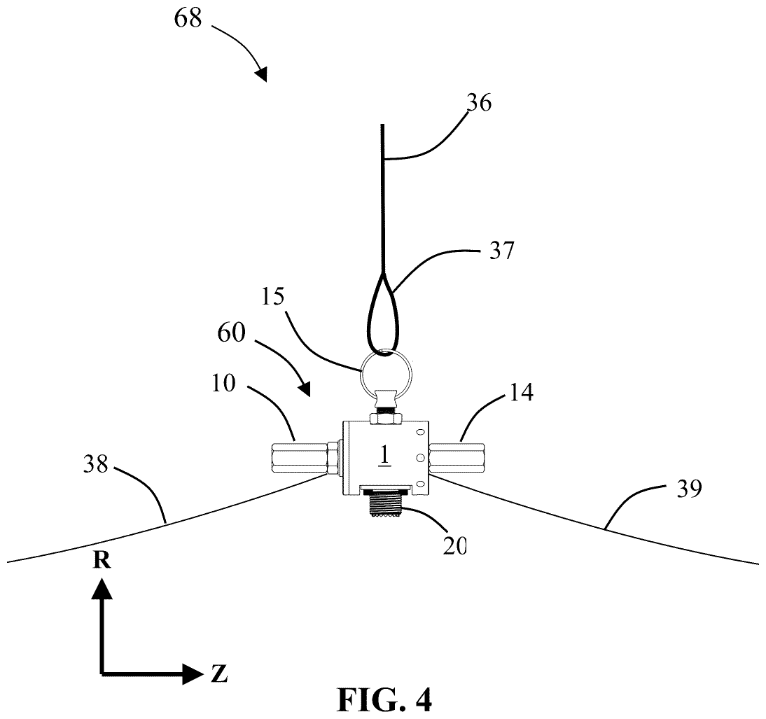

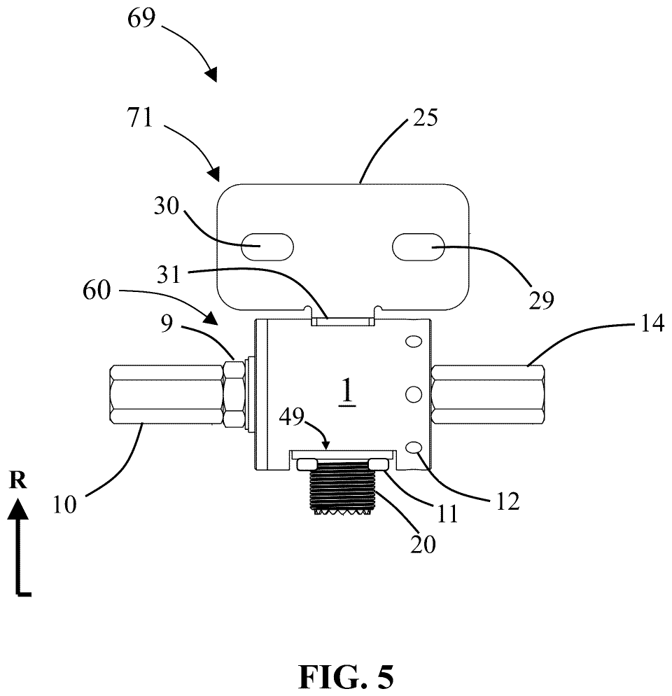

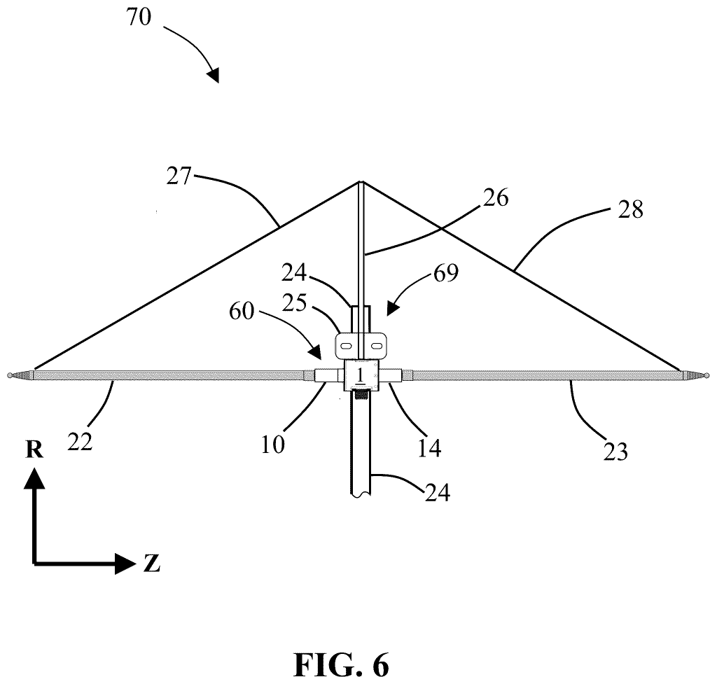

Referring still to FIG. 2, recessed flat surface 13 and coaxial connector 20 may be aligned on a same centerline so that when suspended (see, e.g., FIG. 4), the force of a coaxial cable (not shown) hanging downward (that is attached to coaxial connector 20) is directly transferred through body 1 to the attachment point (e.g., split ring 15) without applying force or torques in any other direction(s). This keeps antenna mount 60 level and reduces torque on coaxial connector 20, thereby helping to extend the lifetime of these components. Recessed flat surface 13 is also aligned on a mid-point (center) of body 1 so that the various attachments (e.g., telescoping antenna sticks, dipole wires, etc.) place an equal amount of force on any mounting brackets (e.g., L-bracket 25, as shown in FIG. 5). Finally, recessed flat surfaces 13 and 49 are recessed into body 1 to create two orthogonal surface features on opposites sides that act as a locking, anti-rotation mechanism against the mounting L-bracket 25 (see FIG. 5) to ensure that body I cannot spin once mounted to a pole 24 (see FIG. 6).

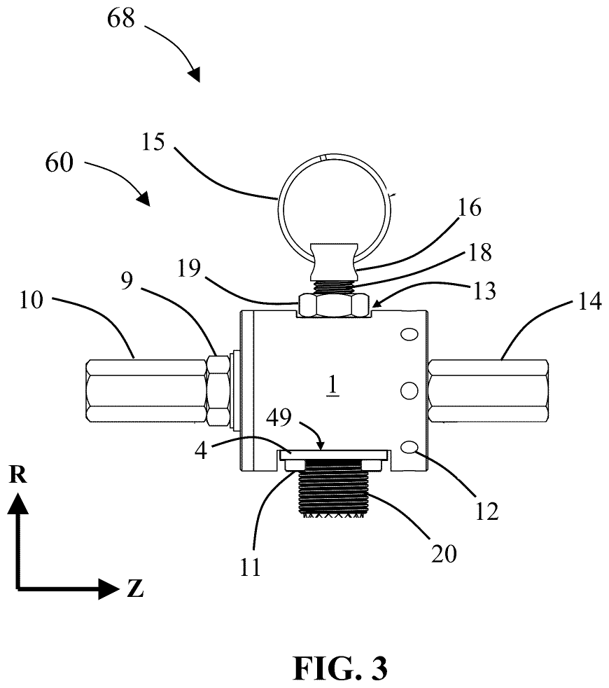

FIG. 3 shows a front elevation view of an example of an antenna assembly 68 with a split ring 15 for holding antenna mount 60 above the ground by a rope or cord. Split ring 15 is attached to a cylindrical nut 16, which screws onto an externally-threaded stud 18 that is itself screwed into body 1 at flat 13. Jam nut 19 is used to prevent stud 18 from unscrewing itself from body 1. The rest of the description of antenna mount 60 is the same as disclosed above with reference to FIG. 2, except that second coupling hex nut 14 is provided in this example, which screws onto stud 5 (see, e.g., FIG. 2).

FIG. 4 shows a front elevation view of an example of an antenna assembly 68 for use with an antenna mount 60 for a dipole wire antenna configuration. Antenna mount 60 is hung from a tree branch, guyed pole, or other elevated attachment point with a hoisting rope 36 that is attached to split ring 15 via loop or knot 37. A pair of independent left and right antenna wires 38 and 39, respectively, are attached to antenna mount 60 via first coupling nut 10 and second coupling nut 14, respectively. This design provides for a standard dipole antenna configuration. First and second coupling hex nuts 10 and 14, respectively, are removable by un-screwing them.

FIG. 5 shows a front elevation view of an example of an antenna mounting assembly 69 with an attached vertical L-bracket 71 for attaching an antenna mount 60 to a pole or other mounting surface (not shown). L-bracket 71 comprises a vertical rectangular mounting plate 25 with a pair of thru-holes 29 and 30 (which can be elongated, oval holes, as illustrated in FIG. 5). L-bracket 71 also has a horizontal attachment tab 31 protruding at right angles (90 degrees) to the vertical mounting plate 25. The rest of the description of antenna mount 60 is the same as disclosed above with reference to FIG. 2, except that second coupling hex nut 14 is provided in this example, which screws onto stud 5.

FIG. 6 shows a front elevation view of an example of an antenna assembly 70 with an antenna mounting assembly 69 for use with a horizontal pair of telescoping dipole antennas 22 and 23 mounted to a vertical pole 24. Telescoping dipole antennas 22 and 23 may be extended outwards to a distance of about 10-20 feet (e.g., 17 feet), or more, depending on the design and number of telescoping tubes. Left telescoping antenna 22 is screwed into first coupling hex nut 10 and right telescoping antenna 23 is screwed into second coupling hex nut 14. Antenna mounting assembly 69 has an L-bracket 25 for attaching antenna mount 60 to a vertical pole 24. Left and right anti-sag support ropes 27 and 28, respectively are attached to the distal ends of left and right telescoping antennas 22 and 23, respectively, for preventing sag of antennas 22 and 23 when fully extended horizontally to, for example, 17 feet. Non-conductive support pole 26 is attached to mount 60 and holds up the left and right anti-sage support ropes 27 and 28. Support pole 26 may be made of any non-conductive material, such as plastic, nylon, or fiberglass reinforced plastic. Antenna assembly 70 may be mounted vertically or horizontally, depending on the desired polarization of the dipole antenna configuration.

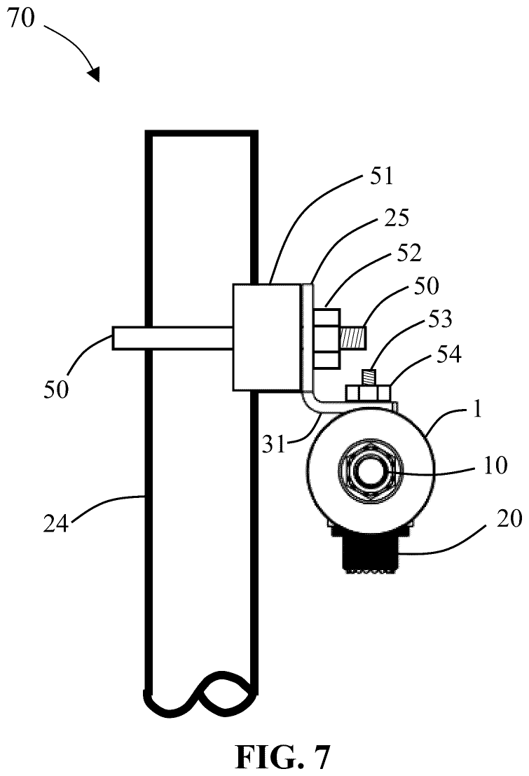

FIG. 7 shows a side elevation view of the antenna mounting assembly 70 shown in FIG. 6 for mounting a pair of telescoping dipole antennas (not shown) to a vertical pole 24. Main body 1 is attached to tab 31 of L-bracket 25 with a removable hex nut 54 that screws onto threaded stub 53. L-bracket 25 is removably attached to pole 24 with a U-shaped bolt 50 that passes through C-shaped block 51. Nut 52 screws onto the threaded ends of U-bolt 50 and secures L-bracket 25 to pole 24. First coupling nut 10 is illustrated, as well as coaxial connector 20 (which points downwards in this example). Dipole antennas 22 and 23 are not shown in this view.

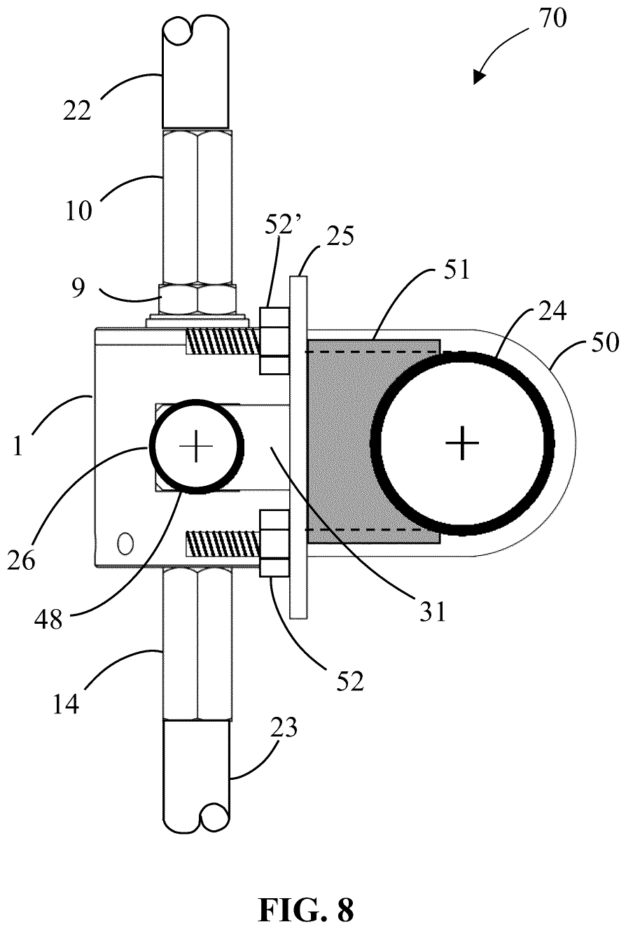

FIG. 8 shows a top (plan) view of the antenna mounting assembly 70 shown in FIG. 6 and FIG. 7 for mounting a pair of telescoping dipole antennas 22 and 23 to a vertical pole 24. Main body 1 is attached to tab 31 of L-bracket 25. L-bracket 25 is removably attached to pole 24 with a U-shaped bolt 50 that passes through C-shaped block 51. Nuts 52 and 52′ screw onto the threaded ends of U-bolt 50 and secures L-bracket 25 and clamped C-shaped support block 51 to pole 24. Left telescoping dipole antenna 22 is attached (e.g., screwed) into first coupling nut 10. Right telescoping dipole antenna 23 is attached (e.g., screwed) into second coupling nut 14. Non-conductive support pole 26 is attached to body 1 through a thru-hole 48 in tab 31.

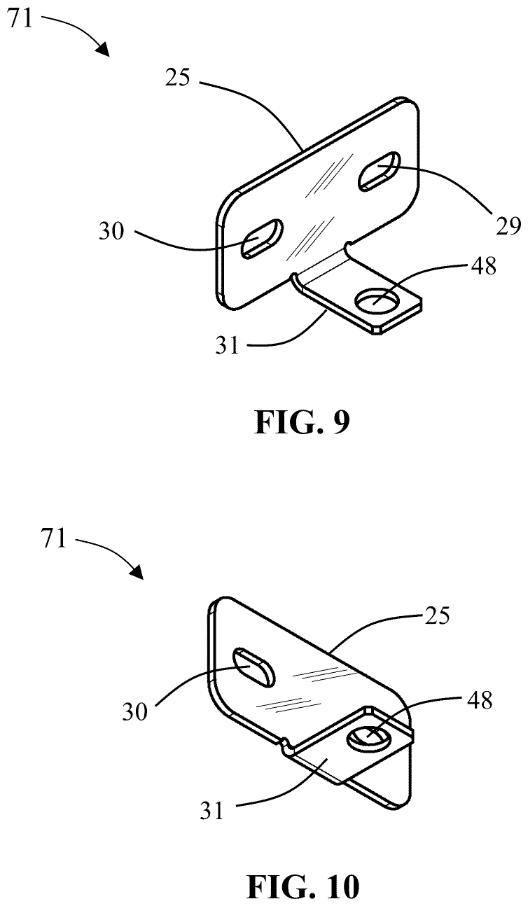

FIG. 9 shows a perspective front view of an example of an L-shaped mounting bracket 71. L-bracket 71 comprises a rectangular mounting plate 25 with a pair of thru-holes 29 and 30 (which may be elongated holes, as illustrated in FIG. 9). L-bracket 71 also has an integral attachment tab 31 protruding at right angles (90 degrees) to the mounting plate 25. Tab 31 has a thru-hole 48 located near the distal end of tab 31.

FIG. 10 shows a perspective bottom view of an example of an L-shaped mounting bracket 71. L-bracket 71 comprises a rectangular mounting plate 25 with a pair of thru-holes 29 and 30 (which may be elongated holes, as illustrated in FIG. 9). L-bracket 71 also has an integral attachment tab 31 protruding at right angles (90 degrees) to the mounting plate 25. Tab 31 has a thru-hole 48 located near the distal end of tab 31.

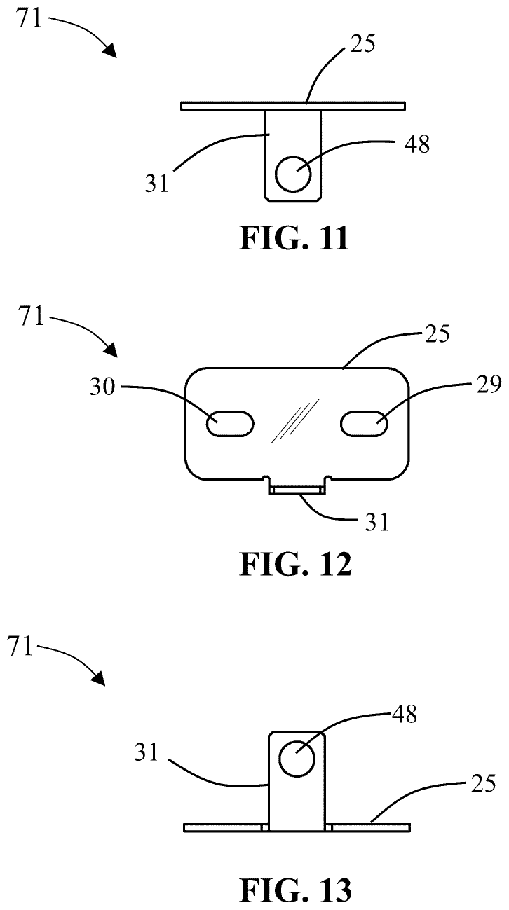

FIG. 11 shows a top (plan) view of an example of an L-shaped mounting bracket 71. L-bracket 71 comprises a rectangular mounting plate 25 with a pair of thru-holes 29 and 30 (which may be elongated holes, as illustrated in FIG. 9). L-bracket 71 also has an integral attachment tab 31 protruding at right angles (90 degrees) to the mounting plate 25. Tab 31 has a thru-hole 48 located near the distal end of tab 31.

FIG. 12 shows a front elevation view of an example of an L-shaped mounting bracket 71. L-bracket 71 comprises a rectangular mounting plate 25 with a pair of thru-holes 29 and 30 (which may be elongated holes, as illustrated in FIG. 9). L-bracket 71 also has an integral attachment tab 31 protruding at right angles (90 degrees) to the mounting plate 25. Tab 31 has a thru-hole 48 located near the distal end of tab 31.

FIG. 13 shows a bottom (plan) view of an example of an L-shaped mounting bracket. L-bracket 71 comprises a rectangular mounting plate 25 with a pair of thru-holes 29 and 30 (which may be elongated holes, as illustrated in FIG. 9). L-bracket 71 also has an integral attachment tab 31 protruding at right angles (90 degrees) to the mounting plate 25. Tab 31 has a thru-hole 48 located near the distal end of tab 31.

FIG. 14 shows a front elevation view of an example of an antenna assembly 72 for use with a telescoping, vertical monopole antenna 22 mounted to an antenna mount 60 that is attached to a tripod base 32 with three legs 33, 34 and with a plurality of radial ground wires 35, 35′, etc. electrically connected to antenna mount 60. In some embodiments, electrical wires 35, 35′, etc. may be inserted in radial holes 12, 12′, etc. (See FIGS. 1-2) for the purpose of attaching and electrically connecting multiple ground radials for vertical monopole antenna installations. Vertically-oriented, telescoping antenna 22 is attached to antenna mount 60. In some embodiments, the proximal end of electrical wires 35, 35′, etc. may have a banana type plug (not shown) that provides a snug and secure electrical and mechanical connection inside of radial holes 12, 12′, etc. Alternatively, in some embodiments, wires 35, 35′, etc. may have a magnetic sleeve (not shown) for attaching wires 35, 35′, etc. to body 1 when body 1 is made of a magnetic material (e.g., steel). In other embodiments that have a non-magnetic main body 1 (e.g., aluminum), then radial holes 12, 12′, etc. may have a thin, cylindrical, steel sleeve (not shown) inserted snugly into radial holes 12, 12′, etc. Alternatively, in other embodiments, wires 35, 35′, etc. may have an externally-threaded metal sleeve (not shown) for screwing into radial holes 12, 12′ when radial holes 12, 12′, etc. are internally-threaded.

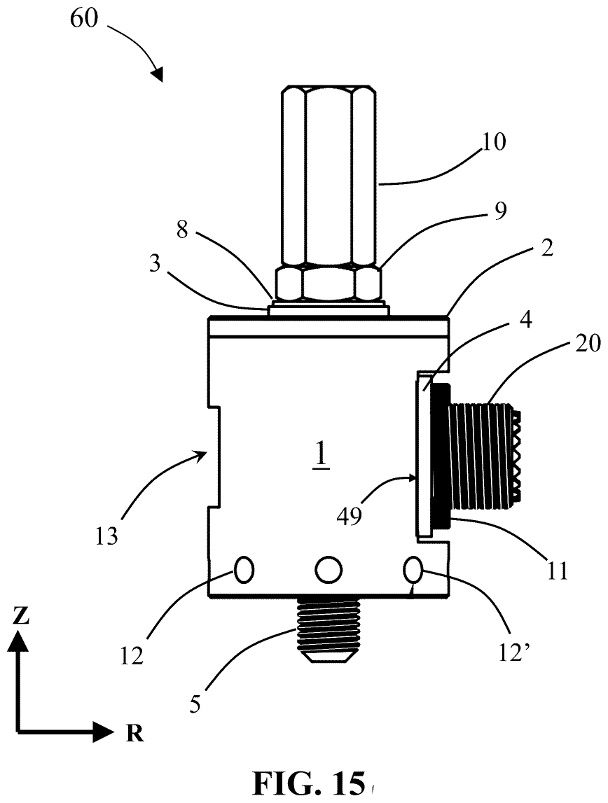

FIG. 15 shows a side elevation view of an example of a cylindrical, hollow antenna mount 60 with a coaxial connection socket 20 and two different attachment features. The description of this example is identical to that previously presented for FIG. 2.

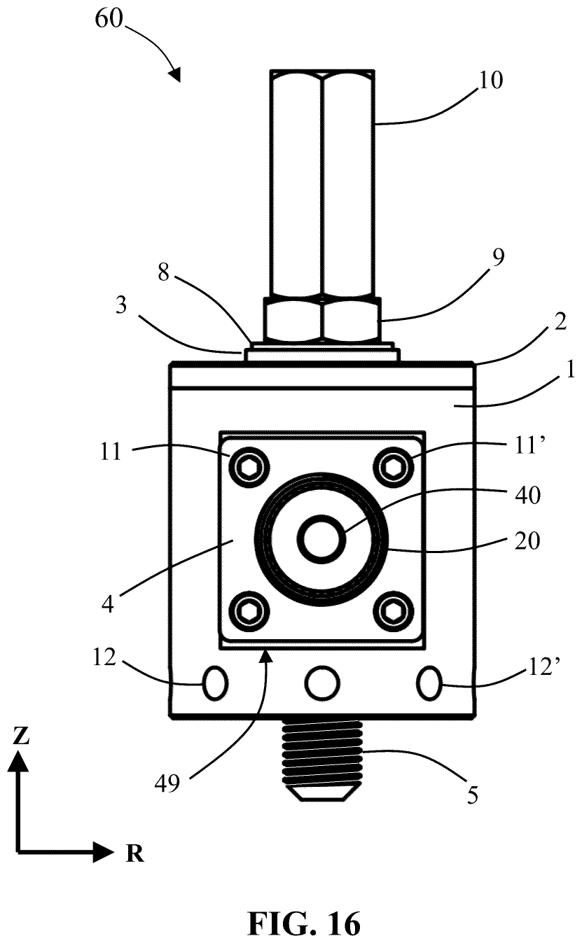

FIG. 16 shows a front elevation view of an example of a cylindrical, hollow antenna mount 60 with a coaxial connection socket 20 and two different attachment features 5 and 10. The description of this example is identical to that previously presented for FIG. 2, with the exception being that the central conductor socket 40 of female coaxial connector 20 is identified.

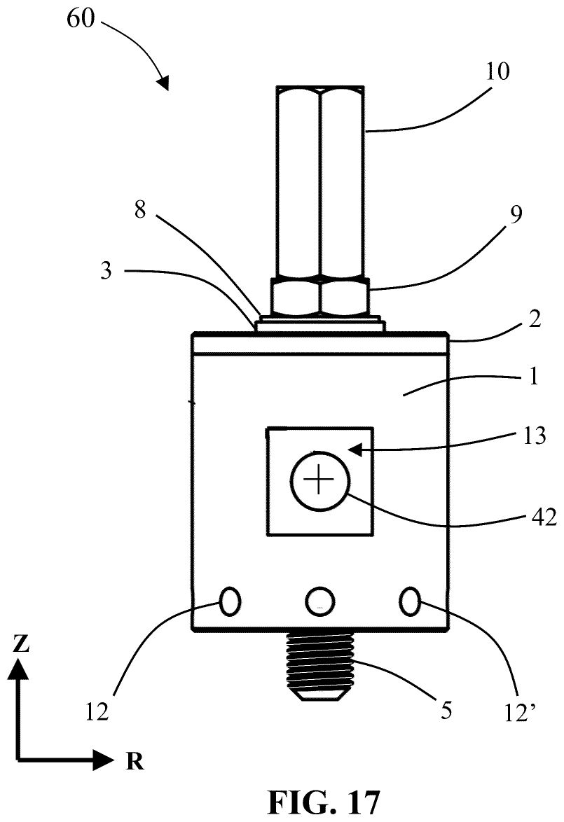

FIG. 17 shows a rear elevation view of an example of a cylindrical, hollow antenna mount 60 showing three different attachment features. The description of this example is identical to that previously presented for FIG. 2, with the exception being that threaded hole 42 is disposed into main body 1 aligned with the center of recessed flat surface 13. Threaded hole 42 may also be described as a “multi-use, an “anti-rotation mounting port” (see FIGS. 4-8 for examples of the use of this anti-rotation mounting port 42).

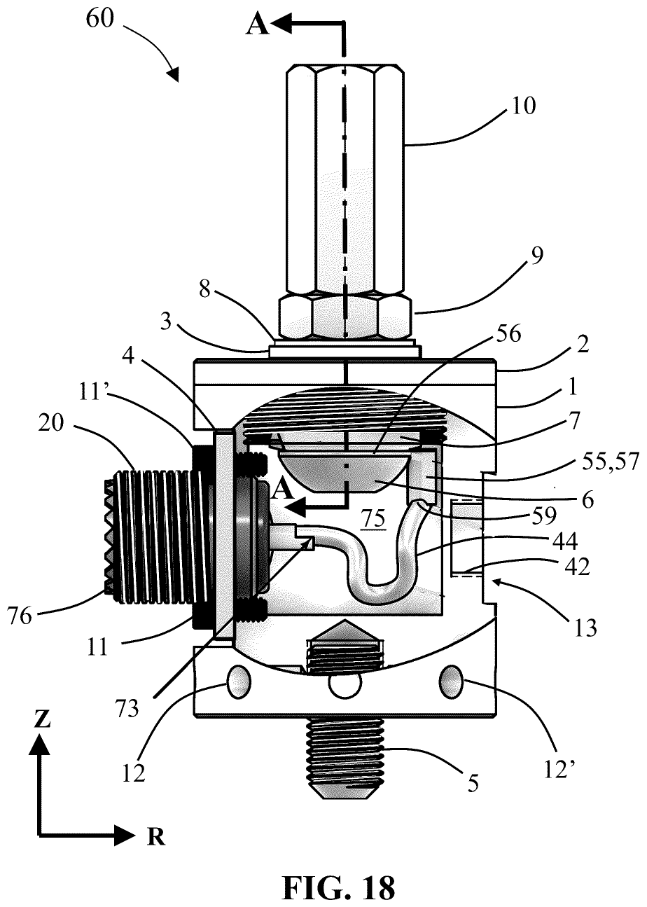

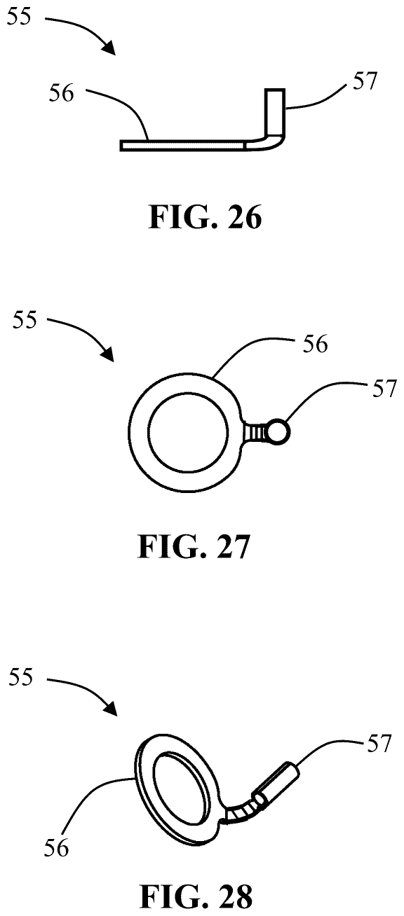

FIG. 18 shows a cross-section side elevation view of an example of a cylindrical, hollow antenna mount 60 with three different attachment features. The description of this example is identical to that previously presented for FIG. 2, with the exception being that the interior volume of main body 1 can be seen in this cutaway illustration. Additional internal features include a hollow, interior volume 75 of main body 1, and a bent, insulated, electrical hookup wire 44 that is soldered to the rear end 73 of the center conductor (not shown) of coaxial connector 20 and connected to a modified ring terminal 55 via a crimped and/or soldered joint 59. Hookup wire 44 may be, for example, a silicone-coated, 18 Ga copper wire. Modified ring terminal 55 comprises a circular ring 56 with a turned-up crimp cylinder 57 that is oriented at 90 degrees to the plane of circular ring 56 (see FIGS. 26-28 for more details). Bent insulated hookup wire 44 is crimped and/or soldered to crimp cylinder 57 of modified ring terminal 55. Circular ring 56 is installed onto and above the lower head of inverted central bolt 6. Insulating seal washer 7 (which may have a rubberized seal ring) is installed above the lower head of button head hex drive bolt 6 and above circular ring 56. Threaded mounting port hole 42 is illustrated in this figure. Note that mounting port hole 42 does not penetrate completely through the wall of main body 1. Rather, mounting port hole 42 is a recessed threaded hole 42. Bottom stud 5 is electrically connected to outer shield 76 of female coaxial connector 20 via conductive main body 1 and via flange 4. Top cap 2 is electrically conductive and connects electrically to the outer shield 76 of coaxial connector 20. Coupling hex nut 10 is electrically connected to the center conductor (not shown) of coaxial connector 20 via conductive central bolt 6, conductive nut 9, conductive lock washer 8, and conductive circular ring 56. Insulating washer 3 electrically isolates central bolt 6 from top cap 2 and main body 1.

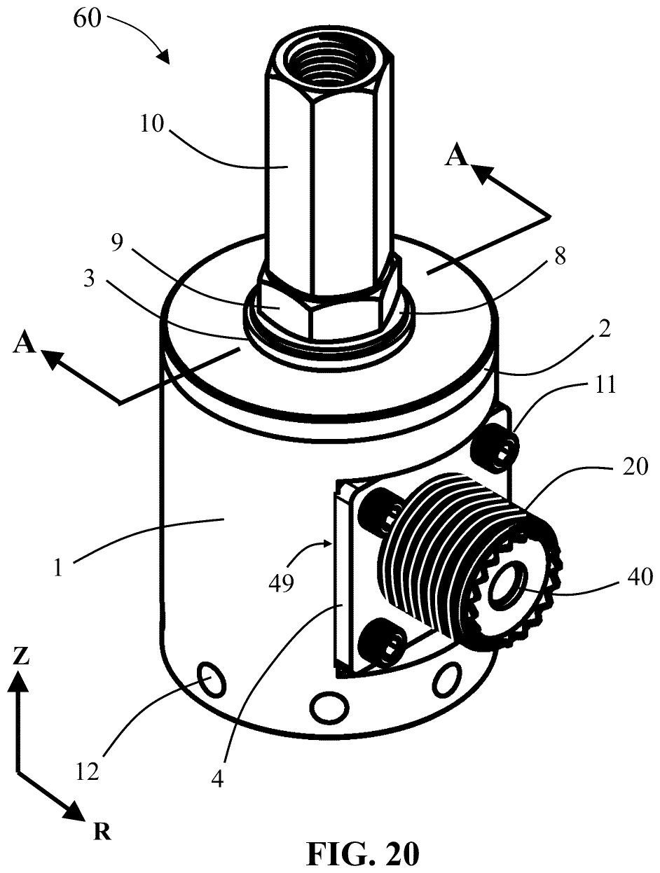

FIG. 19 shows a cross-section (Sec A-A, see FIG. 20) side elevation view of an upper section of an example of a cylindrical antenna mount 60. The cross-section of main body 1 can be seen, as well as the cross-section of top cylindrical cap 2. A second central hole 62 is disposed in the center of top cap 2 and aligned with the centerline (i.e., Z-axis). Disposed inside of bore hole 62 is an inverted central bolt 6. Insulating sealing washer 7 is disposed in-between the head of inverted central bolt 6 and the bottom face of top cap 2. Insulating sealing washer 7 electrically isolates the ring terminal 55 (not shown, see FIG. 18) from the metallic main body 1. Insulating sleeve washer 3 fits snugly around bolt 6, which electrically isolates bolt 6 from metallic top cap 2 and metallic main body 1. Internal-toothed lock washer 8 is disposed above sleeve washer 3. Hex nut 9 is screwed onto bolt 6, above lock washer 8. First coupling hex nut 10 is partially screwed onto an upper portion 47 of bolt 6, leaving an upper section 46 of internally-threaded hex nut 10 that is free for future use.

FIG. 20 shows a perspective view of an example of a cylindrical, hollow antenna mount 60. The description of this example is identical to that previously presented for FIG. 2, with the exception being that the center conductor sleeve 40 is illustrated in this figure.

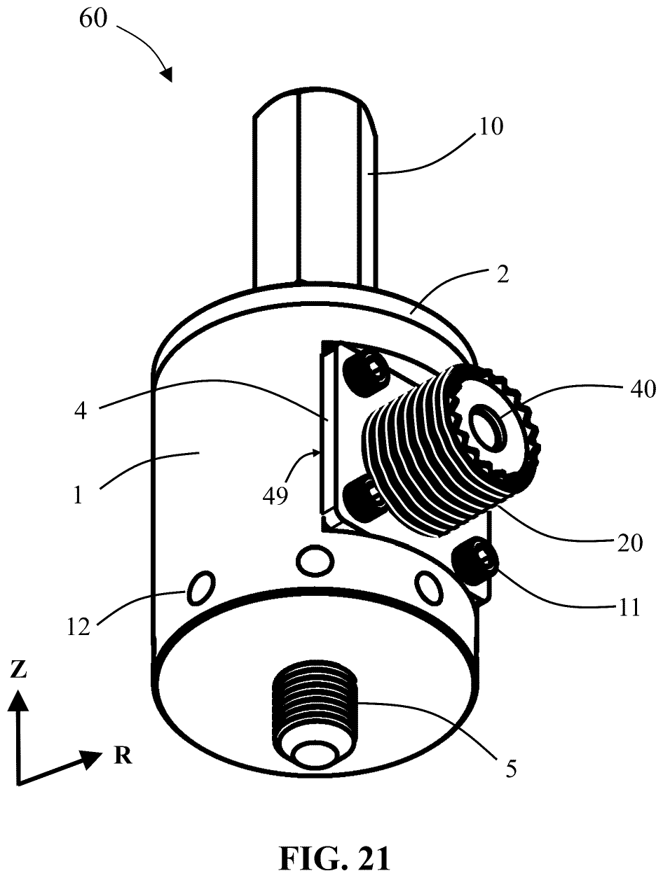

FIG. 21 shows a perspective view of an example of a cylindrical, hollow antenna mount 60. The description of this example is identical to that previously presented for FIG. 2, with the exception being that the center conductor sleeve 40 is illustrated in this Figure.

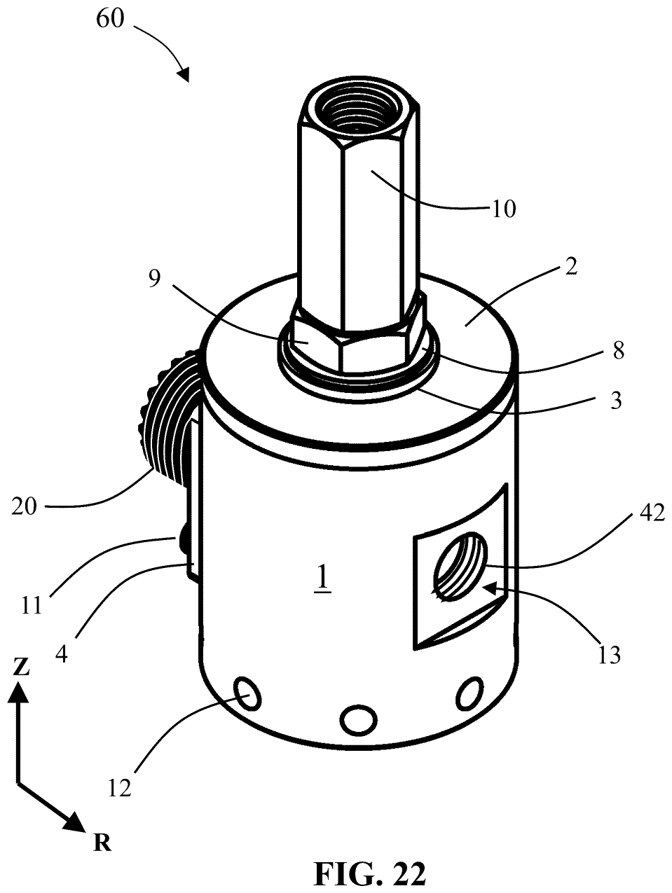

FIG. 22 shows a perspective view of an example of a cylindrical, hollow antenna mount 60. The description of this example is identical to that previously presented for FIG. 2, with the exception being that the internally-threaded, mounting port hole 42 can be seen centered inside of recessed flat surface 13. Recessed flat surface 13 may be milled across main body 1.

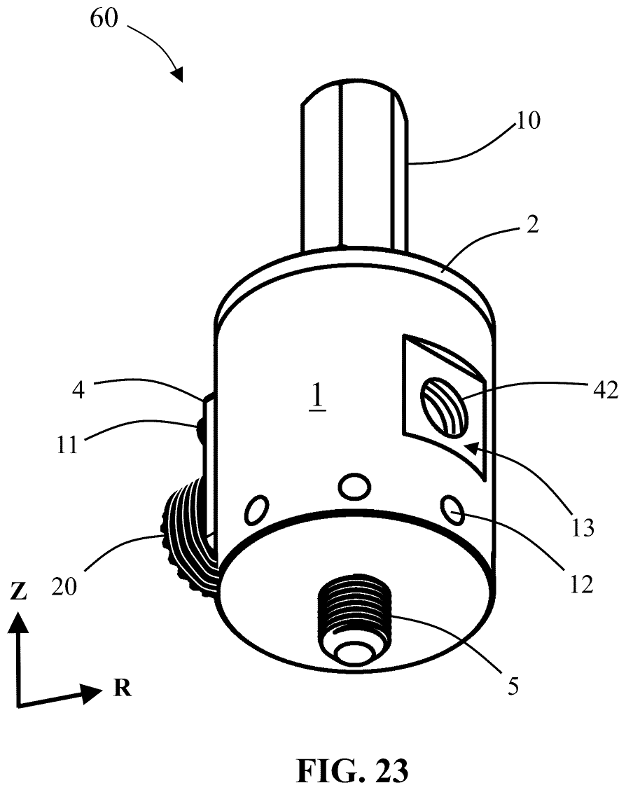

FIG. 23 shows a perspective view of an example of a cylindrical, hollow antenna mount 60. The description of this example is identical to that previously presented for FIG. 2, with the exception being that the internally-threaded, mounting port hole 42 can be seen centered inside of recessed flat surface 13. Recessed flat surface 13 may be milled across main body 1.

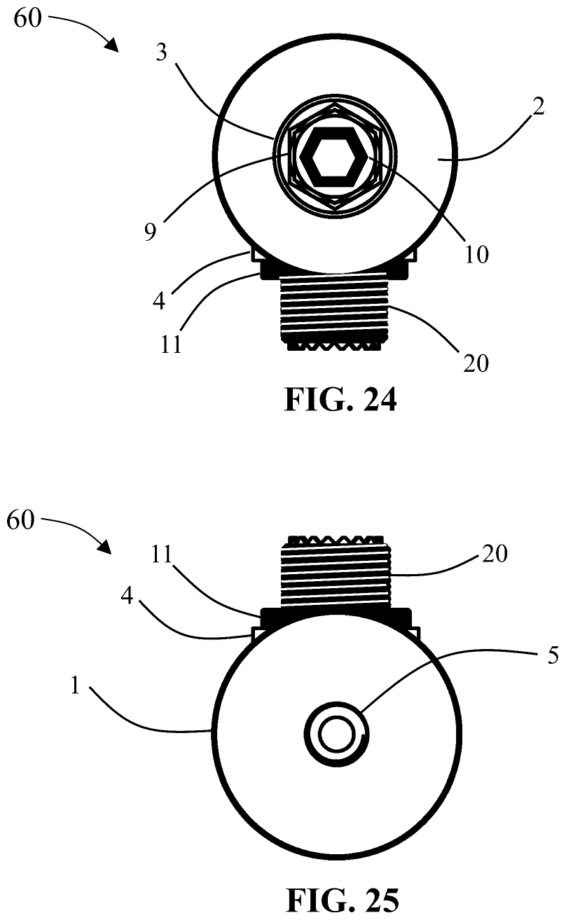

FIG. 24 shows a top view of an example of a cylindrical, hollow antenna mount 60. The description of this example is identical to that previously presented for FIG. 2.

FIG. 25 shows a bottom view of an example of a cylindrical, hollow antenna mount 60. The description of this example is identical to that previously presented for FIG. 2.

FIG. 26 shows a side elevation view of an example of a modified ring terminal 55. Modified ring terminal 55 is an electrical component that comprises a circular ring 56 with an attached crimp cylinder 57 that normally lays in the plane of circular ring 56. But, in this example, ring terminal 55 has been modified so that the crimp cylinder 57 has been bent up or down (i.e., turned up or down) at 90 degrees to the plane of circular ring 56. This allows the modified ring terminal 55 to fit snugly inside of the small, hollow interior volume 75 of main body 1 (see FIG. 18).

FIG. 27 shows a top view of an example of a modified ring terminal 55. The description of this example is identical to that previously presented for FIG. 26.

FIG. 28 shows a perspective view of an example of a modified ring terminal 55. The description of this example is identical to that previously presented for FIG. 26.

FIG. 29A shows a side elevation view of an example of a cylindrical top cap 2. Top cap 2 has an upper cylindrical section 63 that may have the same outer diameter as the outer diameter of cylindrical main body 1. Top cap 2 also has an integral (one-piece) lower cylindrical portion 61 that is externally-threaded. The outer diameter of lower cylindrical portion 61 is smaller than the outer diameter of upper cylindrical section 63 of top cap 2.

FIG. 29B shows a side elevation cross-section view (section B-B) of an example of a cylindrical top cap 2. Top cap 2 has an upper section 63 that has the same outer diameter as the outer diameter of main body 1. Top cap 2 also has an integral (one-piece), lower cylindrical portion 61 that is externally-threaded. The outer diameter of lower portion 61 is smaller than the outer diameter of upper section 63 of top cap 2. A (unthreaded) second central hole 62 is disposed through the thickness of top cap 2 and has a centerline that is coincident with the centerline of top cap 2 along the Z-axis. Top cap 2 is screwed into main body 1 with an optional elastomeric O-ring seal disposed in-between top cap 2 and main body 1.

FIG. 30 shows a side elevation cross-section view (section C-C) view of an example of a main body 1. Main body 1 comprises a vertical, partially-threaded, first central hole 64 which has centerline aligned with the centerline of the main body 1 along the Z-axis. Upper section 65 of central hole 64 is internally-threaded to receive the threaded portion of top cap 2 (not shown). A radial bore hole 66 can be seen, which is oriented radially outwards from the centerline Z-axis and is aligned with coaxial connector 20 (not shown). A pair of 180-degree opposed, radial holes 12 and 12′ are shown, located in the lower part of main body 1. Finally, a vertical, internally-threaded bottom hole 67 is disposed in the bottom of body 1, for accepting, for example, a threaded stud 5 (not shown). In some embodiments, the vertical height, A, of recessed flat 49 is greater than the vertical height, B, of recessed flat 13 (i.e., A>B).

FIG. 31 shows a side elevation cross-section view (section D-D) view of an example of a main body 1. Main body 1 comprises a vertical, partially-threaded, first central hole 64 which has centerline aligned with the centerline of the main body 1 along the Z-axis. Vertical central hole 64 defines a hollow, internal volume 75 of main body 1. Upper section 65 of central hole 64 is internally-threaded for receiving the threaded portion of top cap 2 (not shown). An unthreaded, radial side thru-hole 66 is oriented radially outwards from the centerline and may hold a coaxial connector 20 (not shown). A pair of 180-degree opposed, radial holes 12 and 12′ are shown located in the lower part of main body 1. A vertical, internally-threaded, bottom hole 67 is disposed in the bottom of body 1, for accepting, for example, a threaded stud 5 (not shown). Finally, a recessed threaded radial side hole 42 is partially-recessed radially inwards through a sidewall of body 1 inside of flat 13 and is internally-threaded to accept attachments.

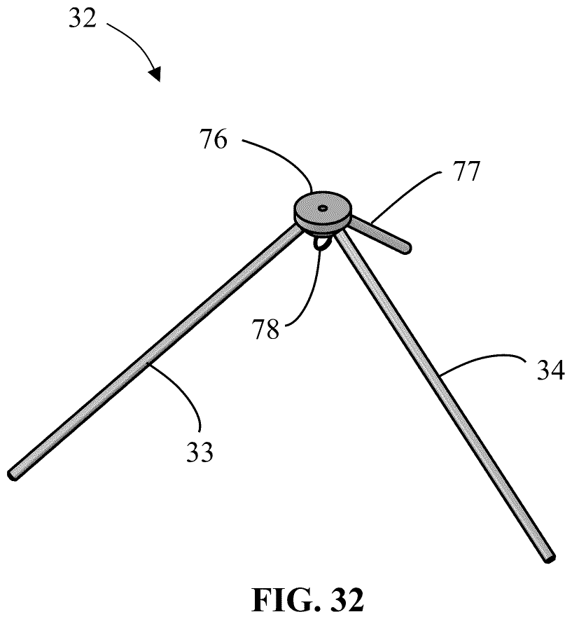

FIG. 32 shows a perspective view of an example of a Z-Pod™ tripod base 32. Tripod base 32 comprises a cylindrical disc (i.e., puck) 76 with three, spread-apart attached legs 33, 34, and 77 that support cylindrical disc (i.e., puck) 76. Support ring 78 is attached underneath disc 76, for holding a weight (not shown) that can be used to hold tripod base 32 solidly on the ground.

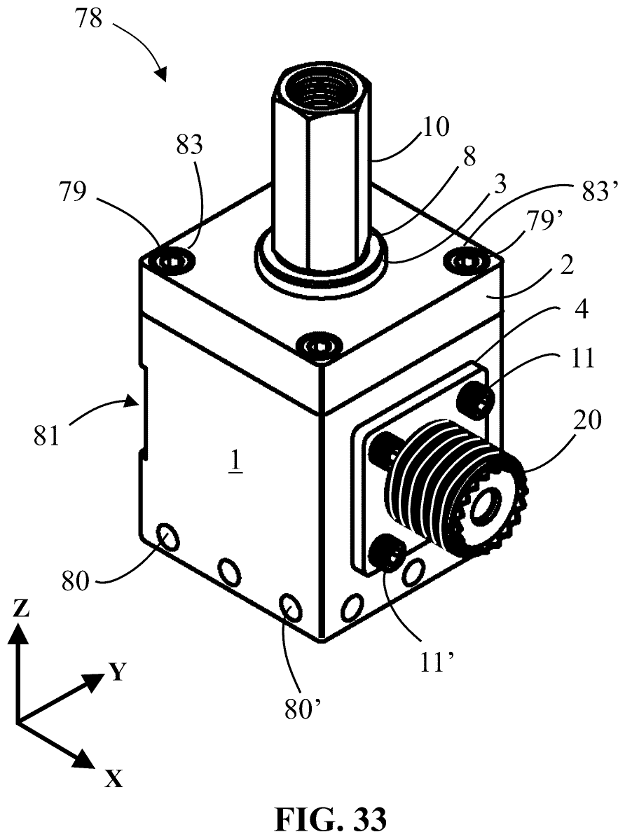

FIG. 33 shows a perspective view of an example of a prismatic antenna mount 78. Prismatic-shaped antenna mount 78 has a prismatic (e.g., cubical), hollow main body 1 that comprises four attachment locations. Prismatic mount 78 has a top square cap 2 that is removably attached to main body 1 with four screws 79, 79′, etc. A first attachment point comprises coupling hex nut 10, which is attached to a threaded, inverted central bolt 6 (hidden in this view) that extends upwards in the Z-direction. Internally-toothed lock washer 8 is disposed in-between coupling hex nut 10 and insulating sleeve washer 3. The second attachment point comprises female coaxial connector 20, which is attached to flange 4, which is attached to main body 1 with four screws 11, 11′, etc. A third attachment point comprises, on an opposite face of the prismatic body 1 (i.e., on a face opposite to the face to which coaxial connector 20 is attached to), a recessed flat surface 81 which has a threaded thru-hole (hidden in this view) centered within recessed flat surface 81. Recessed flat surface 81 is milled in a direction parallel to the Y-axis across the entire side of main body 1. Finally, a plurality of parallel, inwardly-facing holes 80, 80, etc. are evenly spaced apart on each face of prismatic mount 78 near the bottom of body 1. Each one of the four side faces of prismatic mount 78 can have 1, 2, 3, 4, or 5 of these of inwardly-facing holes 80, 80′, etc., which are aligned parallel to either an X-axis or Y-axis direction (depending on the particular face). Note that the overall height of prismatic antenna mount 78 along the Z-direction may be the same or longer than the mount's other two orthogonal widths in the X- and Y-directions.

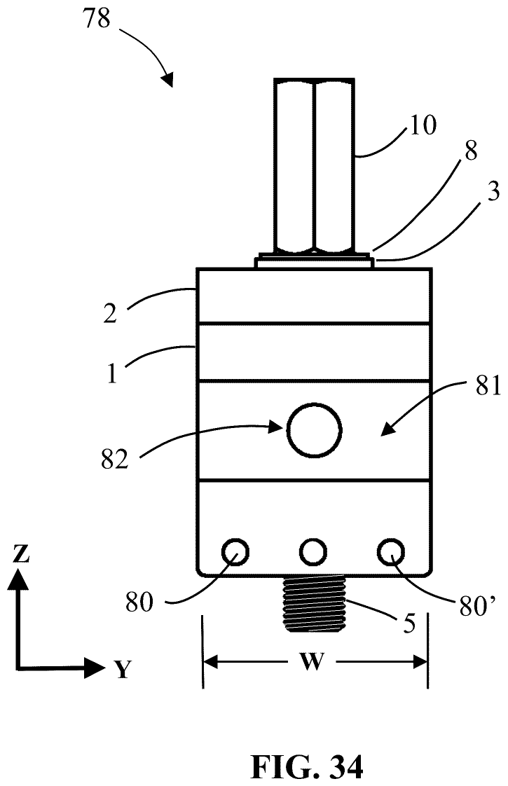

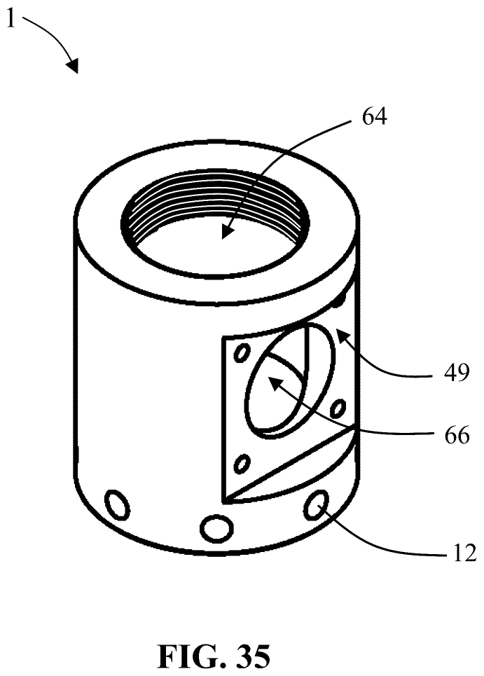

FIG. 34 shows a side elevation view of an example of a prismatic (e.g., cubical) antenna mount 78. Prismatic-shaped antenna mount 78 has a prismatic, hollow main body 1 that comprises four attachment points. Prismatic mount 78 has a top square cap 2 that is removably attached to main body 1 with four screws 79, 79′, etc., (See FIG. 33). A first attachment point comprises coupling hex nut 10, which is attached to a threaded, inverted, central bolt 6 (hidden in this view) that extends upwards in the Z-direction. Internally-toothed lock washer 8 is disposed in-between coupling hex nut 10, lock washer 8, and insulating sleeve washer 3. The second attachment point comprises female coaxial connector 20 (hidden in this view). The third attachment point comprises, on an opposite face of the prismatic body 1, a recessed flat surface 81 (with a width, W, parallel to the Y-axis direction), which has a threaded through hole 82 centered within recessed flat surface 81. A fourth attachment point comprises a bottom threaded stud 5. A plurality of inwardly-facing holes 80, 80, etc. are evenly disposed on each face of prismatic mount 78 near the bottom of body 1. Each one of the four side faces of prismatic mount 78 can have 1, 2, 3, 4, or 5 of these inwardly-facing holes 80, 80′, etc., which are aligned parallel to either an X-axis or Y-axis direction (depending on the particular face). Note that the overall height of prismatic antenna mount 78 along the Z-direction is longer than the mount's width in the orthogonal Y-direction, in this example. In other embodiments, prismatic mount 78 may have a cubical shape.

FIG. 35 shows a perspective view of an example of a cylindrical main body 1. Main body 1 comprises a vertical partially-threaded first central hole 64, a radial side thru-hole 66, a first recessed flat side surface 49, and a radially-oriented hole 12.

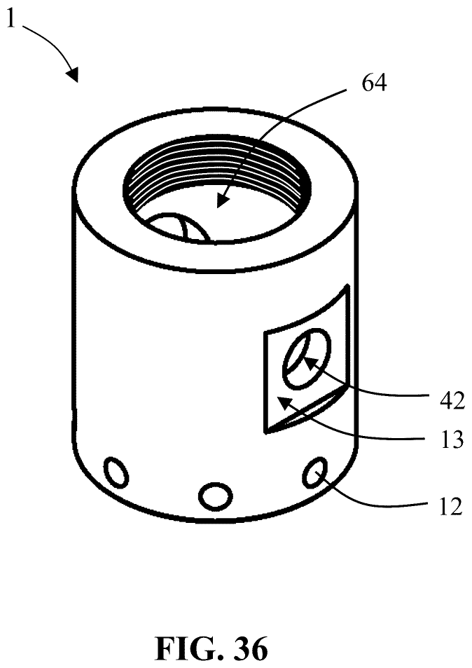

FIG. 36 shows a perspective view of an example of a cylindrical main body. 1 Main body 1 comprises a vertical partially-threaded first central hole 64, a recessed threaded radial side hole 42 a second recessed flat side surface 13, and a radially-oriented hole 12.

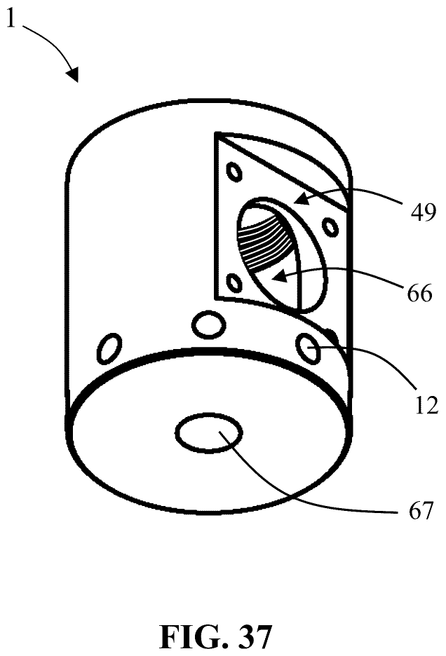

FIG. 37 shows a perspective view of an example of a cylindrical main body 1. Main body 1 comprises a radial side thru-hole 66, a first recessed flat side surface 49, a radially-oriented hole 12, and a vertical threaded bottom hole 67.

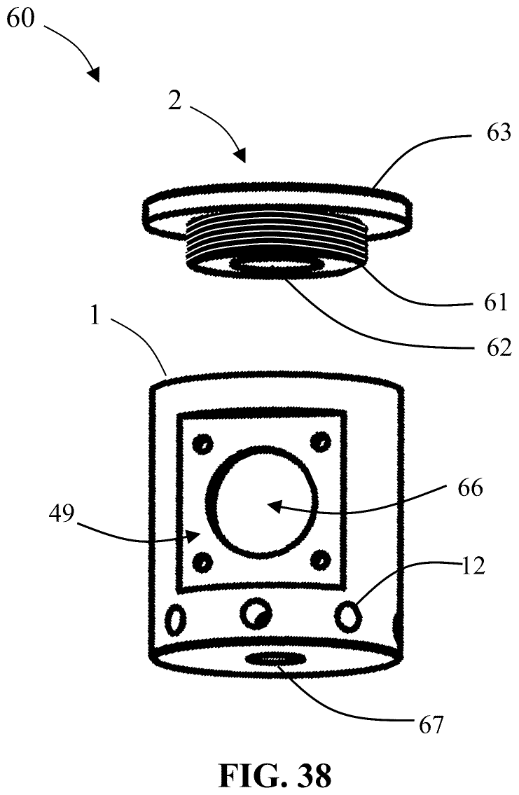

FIG. 38 shows a perspective exploded view of an example of a cylindrical main body land a cylindrical top cap 2. Main body 1 comprises a radial side thru-hole 66, a first recessed flat side surface 49, a radially-oriented hole 12, and a vertical threaded bottom hole 67. Cylindrical top cap 2 comprises an upper cylindrical portion 63 and an integral, externally-threaded lower portion 61 that has a smaller diameter than the diameter of upper cylindrical portion 63. A second central hole 62 is disposed through the center of cylindrical top cap 2.

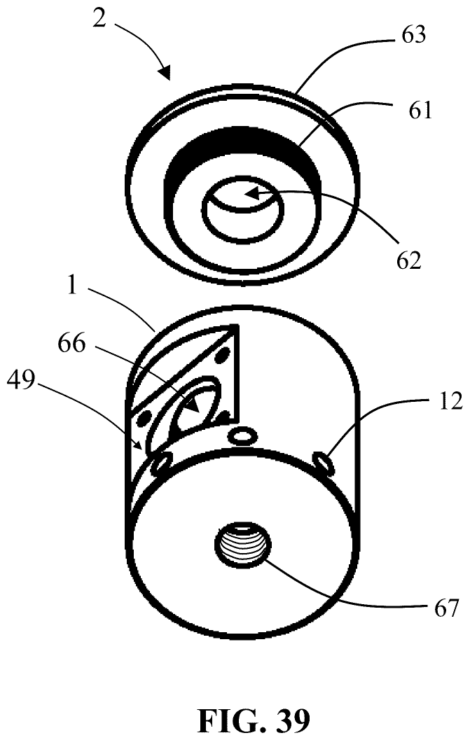

FIG. 39 shows a perspective exploded view of an example of a cylindrical main body 1 and a cylindrical top cap 2. Main body 1 comprises a radial side thru-hole 66, a first recessed flat side surface 49, a radially-oriented hole 12, and a vertical threaded bottom hole 67. Cylindrical top cap 2 comprises an upper cylindrical portion 63 and an integral, externally-threaded lower portion 61 that has a smaller diameter than the diameter of upper cylindrical portion 63. A second central hole 62 is disposed through the center of cylindrical top cap 2.

In some embodiments, cylindrical antenna mount 60 (or prismatic antenna mount 78) may be tightly sealed to prevent any water or dust from infiltrating inside the hollow, main body 1, with, for example, an O-ring seal.

In some embodiments, the Z-axis of cylindrical mount 60 or cubical antenna mount 78 may be oriented vertically and the R-axis is oriented horizontally, with respect to the ground. In other embodiments, the Z-axis of cylindrical mount 60 may be oriented horizontally, with respect to the ground.

In some embodiments, coaxial connector 20 may be a male connector, instead of a female connector. The male coaxial connector may be a PL-259 UHF-type of coaxial connector 20.

In some embodiments, all three orthogonal dimensions of a prismatic antenna mount 78 can all have different lengths from each other.

While several modes for carrying out the many aspects of the present teachings have been described in detail, those familiar with the art to which these teachings relate will recognize various alternative aspects for practicing the present teachings that are within the scope of the appended claims. The above description and accompanying drawings are illustrative and representative of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

Moreover, the present concepts expressly include combinations and sub-combinations of the described elements and features. The detailed description and the drawings are supportive and descriptive of the present teachings, with the scope of the present teachings defined solely by the claims. Words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example.

I claim:

1. An antenna mount, comprising:
a cylindrical main body comprising:
a vertical partially-threaded first central hole, a radial side thru-hole, a vertical threaded bottom hole, and a recessed threaded side radial hole;
a first recessed flat side surface;
a second recessed flat side surface; and
a hollow interior volume defined by the vertical partially-threaded first central hole in the cylindrical main body;
wherein a first centerline of the vertical partially-threaded first central hole is coincident with a second centerline of the cylindrical main body.

2. The antenna mount of claim 1,
further comprising a cylindrical top cap screwed into the vertical partially-threaded first central hole in the cylindrical main body;
wherein the cylindrical top cap comprises:
an upper cylindrical portion,
an integral externally-threaded lower cylindrical portion, and
a second central hole.

3. The antenna mount of claim 2, further comprising an inverted central bolt extending upwards through the second central hole of the cylindrical top cap.

4. The antenna mount of claim 3, further comprising an insulating sleeve washer disposed in-between the inverted central bolt and the second central hole of the cylindrical top cap.

5. The antenna mount of claim 4, further comprising a first hex nut threaded onto the inverted central bolt and disposed above the insulating sleeve washer.

6. The antenna mount of claim 5, further comprising:
a first hex coupling nut partially-threaded onto the inverted central bolt and disposed above the first hex nut;
a second hex coupling nut screwed onto a central threaded stud that is screwed into the vertical threaded bottom hole in the cylindrical main body; and
a split ring attached with a cylindrical nut and a jam nut to a threaded stud that is screwed into the recessed threaded radial side hole.

7. The antenna mount of claim 5, further comprising a first hex coupling nut partially-threaded onto the inverted central bolt and disposed above the first hex nut.

8. The antenna mount of claim 3, further comprising an insulating sealing washer disposed in-between a head of the inverted central bolt and a bottom surface of the integral externally-threaded lower cylindrical portion of the cylindrical top cap.

9. The antenna mount of claim 3, wherein the inverted central bolt is electrically insulated from the cylindrical main body and the cylindrical top cap.

10. The antenna mount of claim 2, wherein the integral externally-threaded lower cylindrical portion of the cylindrical top cap has a smaller outer diameter than an outer diameter of the cylindrical top cap.

11. The antenna mount of claim 1, further comprising a central threaded stud that is screwed into the vertical threaded bottom hole.

12. The antenna mount of claim 1, wherein the cylindrical main body further comprises a plurality of radially-oriented, uniformly spaced radial holes configured for holding and electrically connecting a plurality of radial ground wire connectors to the cylindrical main body.

13. The antenna mount of claim 12, wherein each radial ground wire has an electrical connection to each one of the radially-oriented, uniformly spaced radial holes comprising a banana plug, a magnetic sleeve, or a threaded metallic sleeve.

14. The antenna mount of claim 1, wherein the recessed threaded radial side hole is positioned on an opposite side of the cylindrical main body from the radial side thru-hole.

15. The antenna mount of claim 14,
wherein the radial side thru-hole is centered on, and passes through, the first recessed side flat surface; and
wherein the recessed threaded radial side hole passes through the second recessed side flat surface.

16. The antenna mount of claim 1, wherein the second recessed flat side surface is aligned at a vertical mid-point of the cylindrical main body.

17. The antenna mount of claim 1, further comprising a coaxial connector positioned in the radial side thru-hole, wherein the coaxial connector has an integral flange that is attached to the cylindrical main body.

18. The antenna mount of claim 17,
further comprising a cylindrical top cap screwed into the vertical partially-threaded first central hole in the cylindrical main body;
wherein the cylindrical top cap comprises:
an upper cylindrical portion,
an integral externally-threaded lower cylindrical portion, and
a second central hole;
further comprising an inverted central bolt extending upwards through the second central hole of the cylindrical top cap; and
further comprising a bent insulated wire;
wherein the coaxial connector has a center conductor that is electrically connected to the inverted central bolt via the bent insulated wire disposed inside of the hollow interior volume.

19. An antenna mount, comprising:
(a) a cylindrical main body comprising:
a vertical partially-threaded first central hole, a radial side thru-hole, a vertical threaded bottom hole, and a recessed threaded side radial hole;
a first recessed flat side surface;
a second recessed flat side surface; and
a hollow interior volume defined by the vertical partially-threaded first central hole in the cylindrical main body;
(b) a cylindrical top cap screwed into the vertical partially-threaded first central hole in the cylindrical main body
wherein the cylindrical top cap comprises:
an upper cylindrical portion,
an integral externally-threaded lower cylindrical portion, and
a second central hole;
(c) an inverted central bolt extending upwards through the second central hole of the cylindrical top cap;
(d) an insulating sleeve washer disposed in-between the inverted central bolt and the second central hole of the cylindrical top cap;
(e) a hex nut threaded onto the inverted central bolt and disposed above the insulating sleeve washer;
(f) a first hex coupling nut partially-threaded onto the inverted central bolt and disposed above the hex nut; and
(g) a coaxial connector disposed in the radial side thru-hole and with an integral flange that is screwed to the cylindrical main body at four places;
wherein a first centerline of the vertical partially-threaded first central hole is coincident with a second centerline of the cylindrical main body; and
wherein the cylindrical top cap comprises:
an upper cylindrical portion,
an integral externally-threaded lower cylindrical portion, and
a second central hole.

20. An antenna mount, comprising:
(a) a cylindrical main body comprising:
a vertical partially-threaded first central hole, a radial side thru-hole, a vertical threaded bottom hole, and a recessed threaded side radial hole;
a first recessed flat side surface;
a second recessed flat side surface; and
a hollow interior volume defined by the vertical partially-threaded first central hole in the cylindrical main body; and
(b) a cylindrical top cap screwed into the vertical partially-threaded first central hole in the cylindrical main body;
wherein the cylindrical top cap comprises:
an upper cylindrical portion,
an integral externally-threaded lower cylindrical portion, and
a second central hole;
(c) an inverted central bolt extending upwards through the second central hole of the cylindrical top cap;
(d) an insulating sleeve washer disposed in-between the inverted central bolt and the second central hole of the cylindrical top cap;
(e) a hex nut threaded onto the inverted central bolt and disposed above the insulating sleeve washer;
(f) a first hex coupling nut partially-threaded onto the inverted central bolt and disposed above the hex nut; and
(g) a coaxial connector disposed in the radial side thru-hole and with an integral flange that is screwed to the cylindrical main body at four places;
(h) a central threaded stud that is screwed into the vertical threaded bottom hole; and
(i) an insulating sealing washer disposed in-between a head of the inverted central bolt and a bottom surface of the integral externally-threaded lower cylindrical portion of the cylindrical top cap;
wherein a first centerline of the vertical partially-threaded first central hole is coincident with a second centerline of the cylindrical main body; and
wherein the cylindrical top cap comprises:
an upper cylindrical portion,
an integral externally-threaded lower cylindrical portion, and
a second central hole wherein the coaxial connector has a center conductor that is electrically connected to the inverted central bolt via a bent insulated wire disposed inside of the hollow interior volume;
wherein the bent insulated wire is attached to a modified ring terminal that has a circular ring that is placed over the inverted central bolt and makes electrical contact with a head of the inverted central bolt;
wherein the cylindrical main body further comprises a plurality of radially-oriented, uniformly spaced radial holes configured for holding a plurality of radial ground wire connectors;
wherein the recessed threaded radial side hole is positioned on an opposite side of the cylindrical main body from the side radial thru-hole;
wherein the radial side thru-hole is centered on, and passes through, the first recessed side flat surface;
wherein the recessed threaded radial side hole passes through the second recessed side flat surface;
wherein the first recessed side flat surface has a first vertical height, A;
wherein the second recessed side flat surface has a second vertical height, B; and
wherein A>B;
wherein a shield of the coaxial connector is electrically connected to the cylindrical main body;
wherein the cylindrical main body and the cylindrical top cap are made of aluminum or an aluminum alloy;
wherein each radial ground wire has an electrical connection to the plurality of radially-oriented, uniformly spaced radial holes comprising a banana plug, a magnetic sleeve, or a threaded metallic sleeve;
wherein the cylindrical top cap has a same outer diameter as the cylindrical main body; and
wherein the integral externally-threaded lower cylindrical portion of the cylindrical top cap has a smaller outer diameter than an outer diameter of the cylindrical top cap.
